(19) United States
(12) Patent Application Publication
(10) Pub. No.: US 2004/0141488 A1
(43) Pub. Date: Jul. 22, 2004

(54) Network architecture for mobile communication system and communication method using the same

(75) Inventors: Young-soo Kim, Seoul (KR); Sung-hyun Cho, Seoul (KR); Chan-soo Hwang, Yongin-city (KR); Won-hyoung Park, Seoul (KR)

Correspondence Address: LEE & STERBA, P.C., Suite 2000, 1101 Wilson Boulevard, Arlington, VA, 22209, US

(73) Assignee: Samsung Electronics Co., Ltd.

(21) Appl. No.: 10/702,045

(22) Filed: Nov. 6, 2003

(30) Foreign Application Priority Data
Nov. 6, 2002 (KR) 2002-68572

(51) Int. Cl. H04Q 7/24

(52) U.S. Cl. 370/338

(57) ABSTRACT

Network architecture for a mobile communication system includes a plurality of Internet protocol (IP) routers that serve as gateways for transmitting data from one mobile terminal to another mobile terminal over a public Internet network. The architecture also includes a home agent (HA) and an authorization authentication accounting (AAA) server, both of which are located on the public Internet network. The HA performs initial registration of mobile terminals, IP routing, and management of mobility of the mobile terminals. The AAA server performs authorization, authentication and accounting for the mobile terminals to allow the mobile terminals access to the public Internet network and stores AAA information of each of the mobile terminals. A plurality of radio access points (RAPs), which are respectively connected to the public Internet network via the IP routers, connect the mobile terminals to the public Internet network.

### BACKGROUND OF THE INVENTION

1. Field of the Invention

The present invention relates to a next-generation mobile communication system, and more particularly, to a network architecture for a next-generation mobile communication system capable of accommodating an Internet Protocol (IP) and a communication method using the same.

2. Description of the Related Art

Network architecture is a very important element of a mobile communication system and can affect the general performance of the mobile communication system. Depending on the network architecture, each element may have different functions. In the past, circuit switches generally accounted for most developments in mobile terminal systems together with conventional wired telephone systems. However, recent efforts have been increasingly made to meet the demand of data communications. As part of this effort, a method of converting packet data into an appropriate type of data for a conventional circuit switch and then transmitting the converted packet data has been proposed. However, the above conversion method has several problems, such as low data transmission speed. Therefore, a new network architecture over which successful transmission of packet data can be guaranteed has been developed.

The Third Generation Partnership Project (3GPP) has proposed a new network architecture that can process both circuit data and packet data in a mobile communication system. The proposed network architecture includes a radio access network (RAN) and a core network (CN), each of which include elements needed to provide mobile communication services. The RAN deals with mobile terminals' wireless access and mobility, and the CN deals with mobile terminals' attempts to access public switched telephone network (PSTN) or the Internet. The RAN includes a radio network controller (RNC) and nodes, i.e., base stations. The RNC carries out handover control, admission control, etc. The nodes communicate with mobile terminals in a wireless manner. The CN includes a mobile service-switching center (MSC) and a serving general-packet-radio-service (GPRS) support node (SGSN) or gateway GPRS support node (GGSN). The MSC connects voice communications to the PSTN and the GGSN connects packet data communications to the Internet.

In the conventional network architecture, user services can be guaranteed in a private network. However, it is expensive to install and manage an access network of a system. In addition, traffic is concentrated on each gateway connecting networks, and it is necessary to redefine a protocol of a control plane for a private access network. Moreover, the conventional network architecture is not appropriate for packet services and needs an additional conversion process in each gateway to be compatible with a packet network, such as the Internet.

Thus, conventional network architecture has a plurality of networks, i.e., the RAN, the CN, and a public network, such as the PSTN or the Internet. In contrast, network architectures for next-generation mobile communication systems are simpler. In addition, the network architectures for next-generation mobile communication systems increasingly adopt an All-Internet protocol (AII-IP) concept, which is based on an Internet protocol (IP) packet network, in order to integrate their sub-networks into a single network. However, the conventional network structure cannot be applied to such AII-IP-based mobile communication systems because of the above-mentioned problems.

### SUMMARY OF THE INVENTION

A feature of an embodiment of the present invention is to provide a network architecture in a next-generation mobile communication system that is compatible with other systems using an Internet protocol (IP).

Another feature of an embodiment of the present invention provides a communication method in the network architecture. In this communication method, control information packet data and user packet data are separately processed and transmitted.

According to an aspect of an embodiment of the present invention, a network architecture for a mobile communication system is provided. The network architecture includes a plurality of Internet protocol (IP) routers, a home agent (HA) located on the public Internet network, an authorization authentication accounting (AAA) server located on the public Internet network, and a plurality of radio access points (RAPs) which are respectively connected to the public Internet network via the IP routers. The IP routers serve as gateways for transmitting packet data from one mobile terminal, which is a sending party, to another mobile terminal, which is a receiving party, over the public Internet network operated by an Internet protocol. The HA carries out initial registration of mobile terminals, IP routing, and management of mobility of the mobile terminals. The AAA server carries out authorization, authentication and accounting for the mobile terminals such that the mobile terminals access the public Internet network and stores AAA information of each of the mobile terminals. The RAPs are accessed by the mobile terminals and connect the mobile terminals to the public Internet network via the IP routers.

According to another aspect of an embodiment of the present invention, a communication method in a network architecture for a mobile communication system is provided. The network architecture includes a plurality of Internet protocol (IP) routers, a home agent, an authorization authentication accounting (AAA) server and a plurality of radio access points (RAPs). The communication method includes transmitting control information data using a first communication method and transmitting user data using a second communication method. The control information data and user data are separately processed and transmitted.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a network architecture for a next-generation mobile communication system according to an embodiment of the present invention;

FIG. 2 is a flowchart of a communication method of transmitting control information packet data and user packet data in the network architecture of FIG. 1;

FIG. 3 is a diagram illustrating a path of transmitting control information data in the network architecture of FIG. 1 using the method of FIG. 2; and

FIG. 4 is a diagram illustrating a path of transmitting user data in the network architecture of FIG. 1 using the method of FIG. 2.

### DETAILED DESCRIPTION OF THE INVENTION

Korean Patent Application No. 2002-68572, filed on Nov. 6, 2002, in the Korean Intellectual Property Office, and entitled: “NETWORK ARCHITECTURE FOR MOBILE COMMUNICATION SYSTEM AND COMMUNICATION METHOD USING THE SAME,” is incorporated herein by reference in its entirety.

The present invention will now be described more fully hereinafter with reference to the accompanying drawings in which embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art.

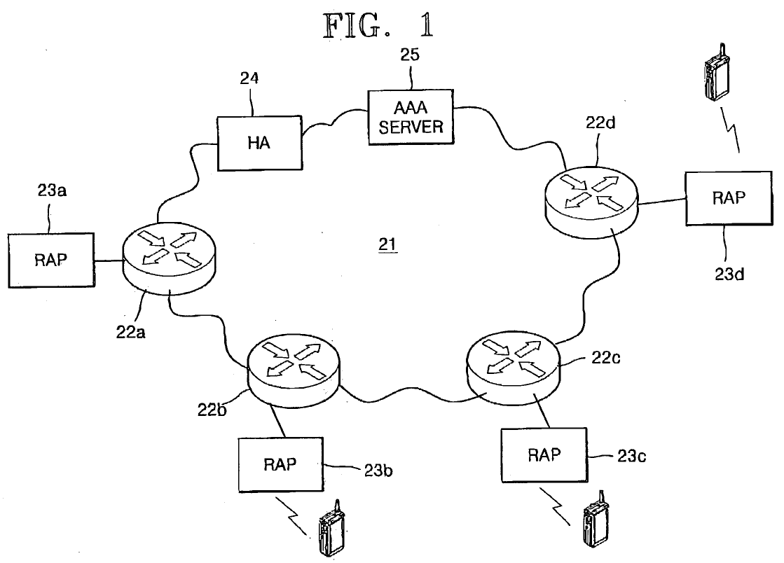

FIG. 1 is a diagram illustrating a network architecture for a next-generation communication system according to an embodiment of the present invention. Referring to FIG. 1, a public Internet network 21 includes a plurality of IP routers 22a through 22d, a home agent (HA) 24, and an authorization authentication accounting (AAA) server 25. A plurality of nodes, i.e., radio access points (RAP) 23a through 23d are connected to the IP routers 22a through 22d, respectively.

For the following explanation of each element of the network architecture of FIG. 1, it is assumed that data is transmitted over the public Internet network 21 according to an Internet protocol such as Internet Protocol version 6 (IPv6) specified by the Internet Engineering Task Force (IETF)'s Request for Comments (RFC) 2460.

The IP routers 22a through 22d serve as gateways for transmitting data between a sending node and a destination node by using typical Internet addresses and routing protocols.

Mobile terminals can access the nodes, i.e., RAPs 23a through 23d, in a wireless manner. In addition, the RAPs 23a through 23d are connected to the IP routers 22a through 22d in a wired manner. The RAPs also connect mobile terminals with the public Internet network 21 and perform router functions as well as general radio link functions. The RAPs 23a through 23d set a signalling path to the RAPs 23a through 23d, the home agent (HA) 24 and the AAA server 25 over a safe communication path, for example, a virtual private network (VPN). Accordingly, when any of the mobile terminals requests mobile communication service, each of RAPs 23a through 23d in the vicinity of the mobile terminal location may communicate with adjacent RAPs 23a through 23d, the HA 24 and the AAA server 25 along a VPN signalling path while guaranteeing security.

Each of the RAPs 23a through 23d serves as a radio network controller (RNC), a gateway general-packet-radio-service (GPRS) support node (GGSN), and a mobile service-switching center (MSC) in the conventional network architecture. Accordingly, the RAPs 23a through 23d may use session initiation protocol (SIP) for call setting, telephony routing over IP (TRIP) for telephone services, E.164 telephone numbers, and protocols defined by the IETF's Telephone Number Mapping (ENUM) working group for corresponding to Domain Name System (DNS). In the meantime, the RAPs 23a through 23d are required to reserve resources on the network for guaranteeing different qualities of service depending on the types of communications, such as voice communications, videophone services, or data communications. The reservation of resources may be carried out using either resource reservation protocol (RSVP) or Differentiated Services (DiffServ) or by using both. RSVP is a protocol that enables resources to be reserved along a predetermined path, while DiffServ is an architecture that transmits data according to their priority. If a mobile terminal moves from the vicinity of one RAP to the vicinity of another RAP, a micromobility protocol operates and quickly carries out a handover and resource reservation changes only in areas that have undergone a change in the setup of the path. Thereafter, a binding update message, generated by the RAP (23a through 23d) in the vicinity of the mobile terminal location, is transmitted to the HA 24 via a corresponding IP router (22a through 22d).

The HA 24 controls all the RAPs 23a through 23d in the public Internet network 21, which is a wired network, and performs a variety of functions, such as initial registration of mobile terminals, IP routing and route optimization, management of the address and migration information of the mobile terminal, tunnelling, and inverse tunnelling. The HA 24 may be constructed to support VPN services of the mobile terminal. In order to manage and support migration of the mobile terminal, the HA 24 receives location information of the mobile terminal contained in the binding update message delivered from the RAPs 23a through 23d when the mobile terminal leaves its home network and then attempts to access a network outside the home network. Then, the HA 24 stores the received location information of the mobile terminal in a database. The HA 24 stores a home IP address of each of the RAPs 23a through 23d as location information of the mobile terminal in the form of a table and, if necessary, transmits data received from the mobile terminal to the RAP 23a through 23d through tunnelling and encapsulation. In other words, if a mobile terminal sends data to its home network with only knowledge of a home IP address of the destination mobile terminal, the HA 24 analyzes the data, extracts location information of the destination mobile terminal from the database based on a result of the analysis and transmits the data to a network where the destination mobile terminal belongs using the RAPs 23a through 23d. The HA 24 may use IETF's mobility IP protocol as a macromobility protocol and Cellular IP or HAWAII as a micromobility protocol. In addition, the HA 24 may use a content transfer protocol for transmitting current connection information and a handoff candidate discovery protocol for a handover.

The AAA server 25 serves as a subscriber server from a mobile IP's point of view and performs authorization of subscribers who attempt to access the public Internet network 21 for mobile terminals, authentication of the subscribers' rights to use the public Internet network 21, and charging the subscribers for access to the public Internet network 21. The AAA server 25 stores AAA information of each mobile terminal. For these functions, the AAA server 25 may use a protocol, such as Remote Authentication Dial in User Service (RADIUS), Diameter, or Common Open Policy Service (COPS). Like the HA 24, the AAA server 25 may be constructed to support VPN services of mobile terminals. The RADIUS protocol is taught by C. Rigney, S. Willens, A. Rubens, and W. Simpson in “Remote Authentication Dial in User Service”, RFC 2865, June 2000, the Diameter protocol taught by P. R. Calhoun, J. Arkko, E. Guttman, G. Zorn, and J. Loughney in “Diameter Base Protocol”, Internet Draft, Draft-ietf-aaa-diameter-11.txt, June 2002, and the COPS protocol taught by D. Durham, J. Boyle, R. Cohen, S. Herzog, R. Rajan, and A. Sastry in “The COPS Protocol”, RFC 2748, January 2000.

In a conventional mobile communication system, equipment for managing mobile terminals' mobility and performing AAA constitute their own private network in a hierarchical manner. In contrast, the network architecture according to an embodiment of the present invention does not constitute an expensive private network. Rather, the network architecture according to an embodiment of the present invention supports a secure communication path, e.g., a VPN, while using a public Internet network.

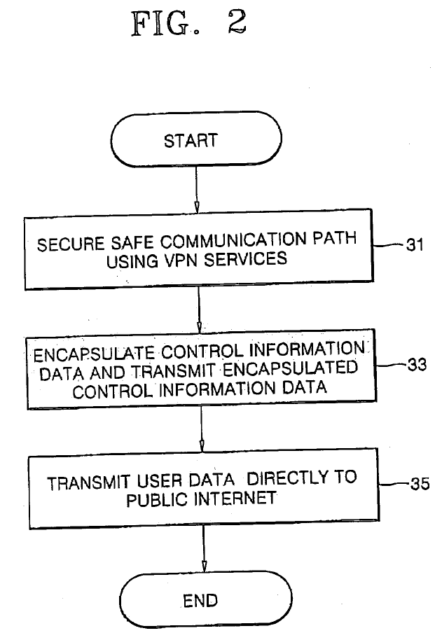

FIG. 2 is a flowchart of a data communication method used in the network architecture of FIG. 1. Communication content transmitted among the RAPs 23a through 23d or control information of a predetermined mobile terminal is encapsulated in the RAPs 23a through 23d, the HA 24 or the AAA server 25 in such a manner that its security can be guaranteed. Thereafter, the encapsulated communication content or control information is transmitted between the RAPs 23a through 23d, between the RAPs 23a through 23d and the home agent 24, and between the RAPs 23a through 23d and the AAA server 25.

More specifically, in step 31, a RAP (23a through 23d) communicates with other RAPs (23a through 23d), the HA 24, and the AAA server 25, thus securing a safe communication path through a predetermined security process. The communication path is used for transmitting control information data. For secured communications, a VPN may be used. In addition, RSVP may be used to prioritize the control information data.

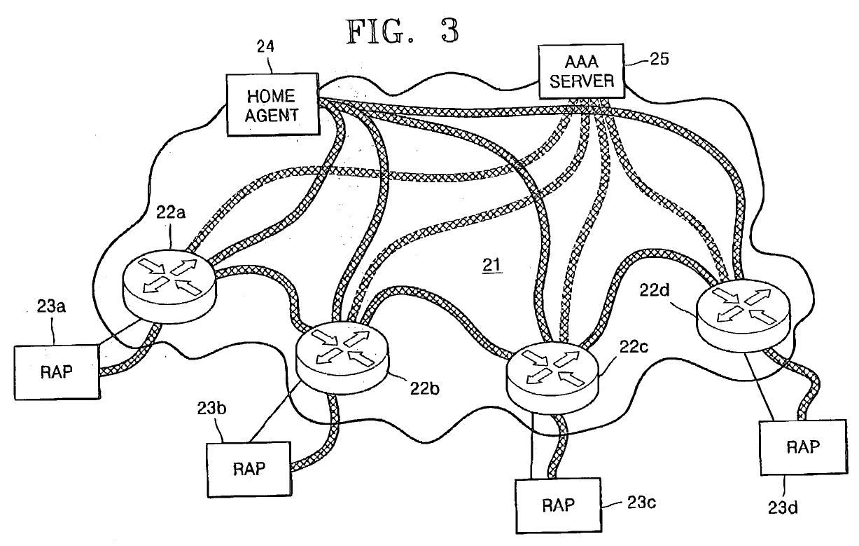

In step 33, the control information data necessary for mobile communication in the network structure of FIG. 1 is transmitted. Before being transmitted, as shown in FIG. 3, the control information data is encapsulated in a method dictated by the VPN or other security service being employed. This encapsulated control information may be given a higher priority than that of the user data to the data using a protocol, such as RSVP. Then, a receiving party, such as other RAPs (23a through 23d), the HA 24, and the AAA server 25, interprets the encapsulated control information data.

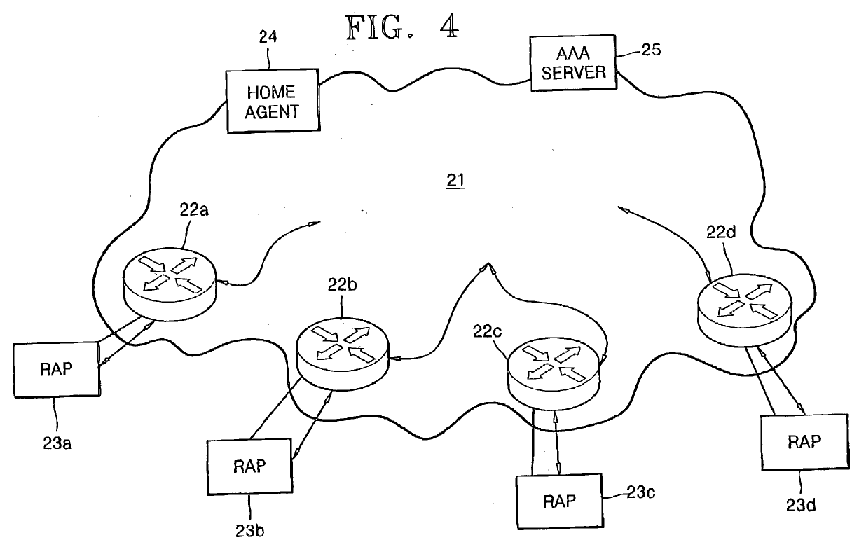

In step 35, user data of a mobile terminal is directly transmitted to the public Internet network 21 via the RAPs 23a through 23d without encapsulation and tunnelling, as shown in FIG. 4.

In other words, in a communication method according to an embodiment of the present invention, the control information data and the user data are separately processed and then are separately transmitted in different manners. The control information data may be provided with more secure transmission that the user data and may be prioritized over the user data.

As described above, according to the present invention, a complicated network architecture is not necessary to transmit control information. The network architecture according to the present invention is compatible with other systems and is highly expandable in terms of system installation. In addition, a system's protocol stack can be simplified, and the installation costs can be considerably reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A network architecture for a mobile communication system, the network architecture comprising:
a plurality of Internet protocol (IP) routers which serve as gateways for transmitting data from one mobile terminal, which is a sending party, to another mobile terminal, which is a receiving party, over a public Internet network;
a home agent (HA) located on the public Internet network, the HA carrying out initial registration of mobile terminals, IP routing, and management of mobility of the mobile terminals;
an authorization authentication accounting (AAA) server located on the public Internet network, separate from the HA, the AAA server carrying out authorization, authentication and accounting for the mobile terminals such that the mobile terminals access the public Internet network and storing AAA information of each of the mobile terminals; and
a plurality of radio access points (RAPs) which are respectively connected to the public Internet network via the IP routers, the RAPs connecting the mobile terminals to the public Internet network.

2. The network architecture of claim 1, wherein the home agent, the AAA server, and the plurality of RAPs are constructed to support a safe communication path.

3. The network architecture of claim 2, wherein the safe communication path includes a virtual private network (VPN).

4. The network architecture of claim 1, wherein at least one of the RAP, the AAA server and the HA encapsulates control information data to be transmitted.

5. The network architecture of claim 4, wherein the RAP assigns a higher priority to encapsulated control information data than to other types of data.

6. The network architecture of claim 1, wherein the RAP directly transmits user data to the public Internet network via the IP routers.

7. The network architecture of claim 1, wherein the RAP transmits location information of a mobile terminal to the HA.

8. The network architecture of claim 1, wherein the HA further performs route optimization.

9. The network architecture of claim 1, wherein the RAP further performs general radio link functions.

10. A communication method in a network architecture for a mobile communication system, the network architecture including a plurality of Internet protocol (IP) routers, a home agent, an authorization authentication accounting (AAA) server and a plurality of radio access points (RAPs), the communication method comprising:
transmitting control information data using a first communication manner; and
transmitting user data using a second communication manner,
wherein the control information data and user data are separately processed and transmitted.

11. The communication method of claim 10, wherein the first communication manner comprises securing a safe communication path by performing communication between the plurality of RAPs, between the RAPs and the home agent, and between the RAPs and the AAA server.

12. The communication method of claim 11, wherein the securing a safe communication path includes using virtual private network (VPN) services.

13. The communication method of claim 12, wherein the first communication manner further comprises encapsulating the control information data.

14. The communication method of claim 13, further comprising setting a higher priority to encapsulated control information data than to user data.

15. The communication method of claim 10, wherein the second communication manner includes directly transmitting the user data of each mobile terminal to the public Internet network.

16. The communication method of claim 10, wherein the second communication manner is less secure than the first communication manner.

17. The communication method of claim 12, wherein the first communication manner further comprises encapsulating the control information data.

18. The communication method of claim 13, further comprising setting a higher priority to encapsulated control information data than to user data.
